(19) United States
(12) Patent Application Publication
(10) Pub. No.: US 2026/0169155 A1
(43) Pub. Date: Jun. 18, 2026

(54) VEHICLE-CABIN RADAR DEVICE AND VEHICLE

(71) Applicant: Mitsubishi Electric Corporation, Tokyo (JP)

(72) Inventors: Yasunori HOSHIHARA, Tokyo (JP); Takumi TAKEI, Tokyo (JP)

(73) Assignee: Mitsubishi Electric Corporation, Tokyo (JP)

(21) Appl. No.: 18/707,889

(22) PCT Filed: Nov. 18, 2021
(86) PCT No.: PCT/JP2021/042350

§ 371 Date: May 7, 2024

(51) Int. Cl. G01S 13/931; G01S 7/03; G01S 13/02; G01S 13/42

(52) U.S. Cl. CPC G01S 13/931; G01S 7/032; G01S 13/426; G01S 2013/0245; G01S 2013/9315

(57) ABSTRACT

A vehicle-cabin radar device includes a signal generating unit to generate a transmission signal, a transmission antenna to radiate the transmission signal generated by the signal generating unit toward a vehicle cabin as a radio wave, a reception antenna including a first reception antenna element and a second reception antenna element to receive a reflected wave of the radio wave radiated from the transmission antenna, the first reception antenna element and the second reception antenna element being provided at an interval, and an interior member exposed to the vehicle cabin. The interior member includes a plate-shaped flat plate portion provided between the transmission and reception antennas and the vehicle cabin in a direction perpendicular to a plane on which the reception antenna is provided, the flat plate portion being provided in parallel to a virtual straight line connecting the first reception antenna element and the second reception antenna element.

### TECHNICAL FIELD

The present disclosure relates to a vehicle-cabin radar device and a vehicle.

### BACKGROUND ART

Conventionally, an occupant detecting device that detects an occupant in a vehicle cabin by using a radar provided in the vehicle has been known (see Patent Literature 1). Further, in general, a radar device can measure the size, position, and the like of an object on the basis of a time difference for each reception antenna when a radio wave is radiated from a transmission antenna and a reflected wave is received by a plurality of reception antennas.

### CITATION LIST

### Patent Literature

Patent Literature 1: JP 2017-181225 A

### SUMMARY OF INVENTION

### Technical Problem

In the radar device for a vehicle cabin, the transmission antenna and the reception antennas may be covered with an interior member of the vehicle cabin for reasons such as improving the appearance and protecting the radar device. In a case where the transmission antenna and the reception antennas are covered with an interior member of the vehicle cabin, an error may occur in the time difference when the reflected wave is received by the reception antennas depending on the shape of the interior member, and thereby sufficient measurement accuracy of the radar device may not be obtained.

The present disclosure solves the above problem, and an object thereof is to provide a vehicle-cabin radar device and a vehicle capable of suppressing an influence of an interior member on measurement accuracy.

### Solution to Problem

A vehicle-cabin radar device according to the present disclosure includes a signal generating unit to generate a transmission signal, a transmission antenna to radiate the transmission signal generated by the signal generating unit toward a vehicle cabin as a radio wave, a reception antenna including a first reception antenna element and a second reception antenna element to receive a reflected wave of the radio wave radiated from the transmission antenna, the first reception antenna element and the second reception antenna element being provided at an interval, and an interior member exposed to the vehicle cabin, in which the interior member includes a plate-shaped flat plate portion that is provided between the transmission and reception antennas and the vehicle cabin in a direction perpendicular to a plane on which the reception antenna is provided, the flat plate portion being provided in parallel to a virtual straight line connecting the first reception antenna element and the second reception antenna element.

### Advantageous Effects of Invention

With a vehicle-cabin radar device and a vehicle of the present disclosure, it is possible to suppress an influence of an interior member on measurement accuracy.

### BRIEF DESCRIPTION OF DRAWINGS

FIG. 1 is a side view illustrating a configuration of a vehicle according to a first embodiment.

FIG. 2 is an enlarged view illustrating a configuration of a vehicle-cabin radar device according to the first embodiment.

FIG. 3 is a diagram illustrating a configuration of a radar unit according to the first embodiment as viewed from a direction perpendicular to a surface of a substrate.

FIG. 4 is a cross-sectional view illustrating the configuration of the radar unit according to the first embodiment as viewed from a side.

FIG. 5 is a cross-sectional view illustrating a reflected wave received by a reception antenna according to the first embodiment as viewed from above.

FIG. 6 is a cross-sectional view illustrating a radio wave radiated from a transmission antenna according to the first embodiment toward a vehicle cabin as viewed from a side.

FIG. 7 is a cross-sectional view illustrating an example of a roof member according to the first embodiment.

### DESCRIPTION OF EMBODIMENTS

Hereinafter, an embodiment according to the present disclosure will be described in detail with reference to the drawings.

### First Embodiment

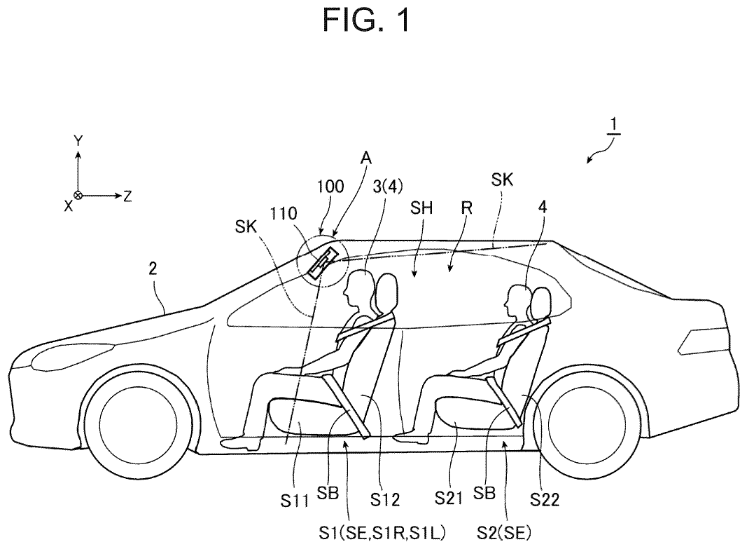

A configuration of a vehicle 1 according to a first embodiment will be described with reference to FIG. 1. FIG. 1 is a side view illustrating the configuration of the vehicle 1 according to the first embodiment. The vehicle 1 according to the first embodiment includes a vehicle body 2 and a vehicle-cabin radar device 100. A vehicle cabin R for a driver 3 and an occupant 4 who is a non-driver to board is formed inside the vehicle body 2, and the vehicle body 2 includes seats SE arranged in the vehicle cabin R and seat belts SB. Note that, in the following description, the driver 3 and the occupant 4 who is a non-driver are also collectively referred to simply as “occupant”. Further, a front direction (left direction in FIG. 1) in which the driver 3 seated on a seat SE faces is defined as a front, and based on this, front, rear, left, and right directions are defined. In addition, in the first embodiment, a front-rear direction is also referred to as a Z-axis direction, and a left-right direction is also referred to as an X-axis direction or a vehicle width direction. Further, in the first embodiment, a vertical direction in FIG. 1 is also referred to as a Y-axis direction or a vehicle height direction.

For example, the seats SE include front seats S1 including a driver's seat on which the driver 3 is seated, and a rear seat S2 disposed behind the front seats S1 in the vehicle 1. Further, for example, the front seats S1 include a front right seat S1R and a front left seat S1L, and one of the front right seat S1R and the front left seat S1L constitutes a driver's seat. Furthermore, each of the front right seat SIR and the front left seat S1L includes, for example, a seat plate S11 for supporting a seated occupant and a backrest S12 for restricting rearward movement of the seated occupant. Similarly, the rear seat S2 includes a seat plate S21 for supporting a seated occupant and a backrest S22 for restricting rearward movement of the seated occupant.

The seat belt SB is provided corresponding to each of the front right seat S1R, the front left seat SIL, and the rear seat S2. A seat belt wearing detection sensor (not illustrated) detects whether each seat belt SB is in a wearing state in which the seat belt SB is worn by the occupant or in a non-wearing state in which the seat belt SB is not worn by the occupant. Note that a plurality of seat belts may be provided corresponding to one seat, and for example, in a case where the rear seat S2 is a seat in which a plurality of occupants can be seated, seat belts SB may be provided by the number of occupants who can be seated corresponding to the rear seat S2.

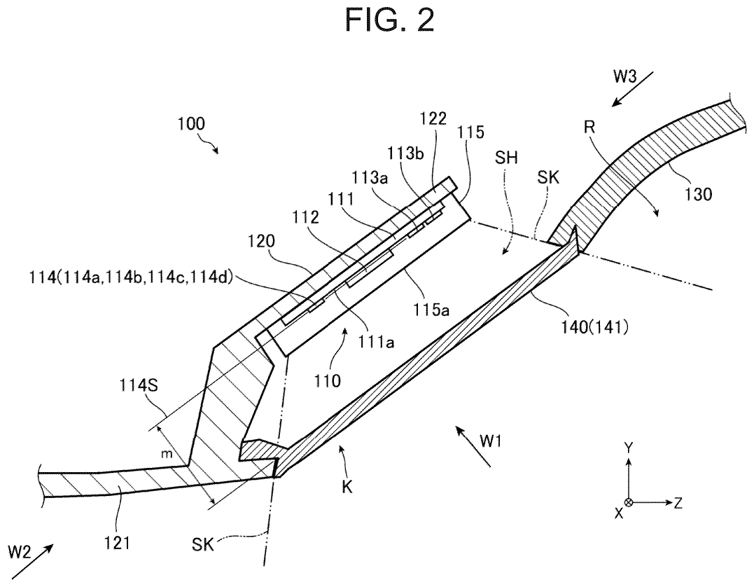

Next, a configuration of the vehicle-cabin radar device 100 will be described with reference to FIG. 2. FIG. 2 is an enlarged view of a portion A in FIG. 1 illustrating a configuration of the vehicle-cabin radar device according to the first embodiment. For example, the vehicle-cabin radar device 100 includes a base member 120, a radar unit 110 supported by the base member 120, a roof member 130, and a radar cover 140 covering the radar unit 110.

The roof member 130 is disposed in an upper part of the vehicle cabin R in such a way as to be exposed to the vehicle cabin R, and partitions the inside of the vehicle cabin R and the outside of the vehicle cabin R in the upper part of the vehicle cabin R. The base member 120 is disposed, for example, in an upper front part of the vehicle cabin R, and constitutes an illumination unit (vehicle component) together with a light emitting unit (not illustrated) that emits light to illuminate the vehicle cabin R. Further, for example, the base member 120 includes an exposed portion 121 exposed to the vehicle cabin R and a support portion 122 that supports the radar unit 110. An opening K is formed between the exposed portion 121 of the base member 120 and the roof member 130.

The radar unit 110 is disposed at a position facing the opening K in a state of being supported by the support portion 122. For example, the radar unit 110 is disposed in a central portion of the vehicle 1 in the X-axis direction. Further, for example, the radar unit 110 is disposed above the front seat S1 and in the upper part of the vehicle cabin R. The radar unit 110 radiates a radio wave toward the vehicle cabin R and acquires information on the inside of the vehicle cabin R on the basis of a received reflected wave. Details of the radar unit 110 will be described later.

The radar cover 140 has a flat plate portion 141 formed in a flat plate shape and exposed to the vehicle cabin R, and is formed of, for example, a hard synthetic resin. Further, for example, the radar cover 140 is disposed between the radar unit 110 and the vehicle cabin R in such a way as to close the opening K. For example, the light emitting unit, the base member 120, the radar unit 110, and the radar cover 140 described above may be unitized as an illumination unit. Note that the radar cover 140 constitutes an interior member in the first embodiment. Details of the radar cover 140 will be described later.

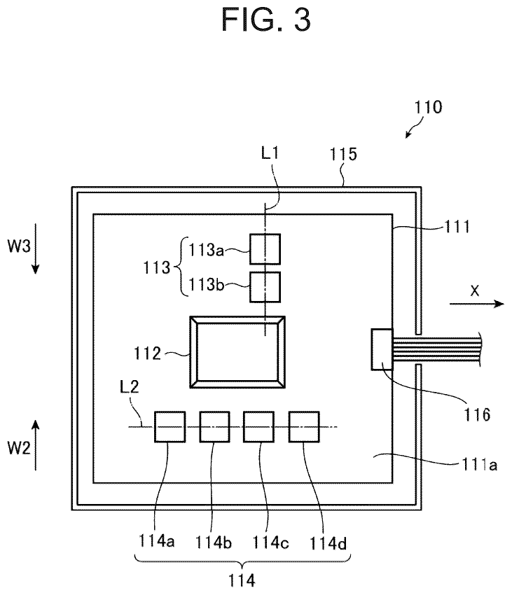

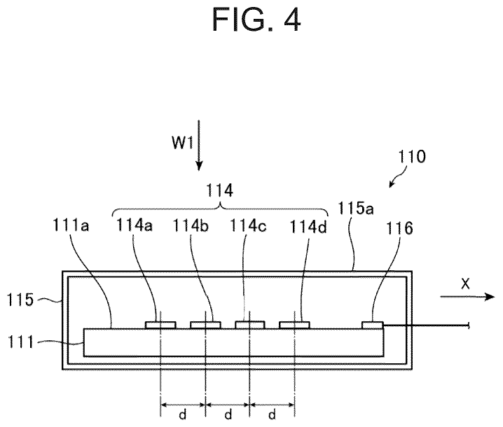

Next, a configuration of the radar unit will be described with reference to FIGS. 2 to 4. FIG. 3 is a diagram illustrating a configuration of the radar unit 110 according to the first embodiment as viewed from a direction (W1 direction illustrated in FIG. 2) perpendicular to a front surface 111a of a substrate 111. FIG. 4 is a diagram illustrating the configuration of the radar unit 110 according to the first embodiment as viewed from a direction (W2 direction illustrated in FIG. 2) parallel to the front surface 111a of the substrate 111. The radar unit 110 includes the substrate 111, a radar circuit unit 112, a transmission antenna 113, a reception antenna 114, an interface unit 116, and a housing 115.

The substrate 111 is made of, for example, a flat printed wiring board, and supports the radar circuit unit 112, the transmission antenna 113, the reception antenna 114, and the interface unit 116. Note that, in the first embodiment, a surface of the substrate 111 on the vehicle cabin R side is referred to as the front surface 111a, and a surface of the substrate 111 on a side opposite to the vehicle cabin R side is referred to as a back surface. For example, the substrate 111 is disposed in the upper front part of the vehicle cabin R so that the front surface 111a faces a lower rear part of the vehicle cabin R.

The radar circuit unit 112 performs processing for radiating the radio wave toward the vehicle cabin R and processing for acquiring information on the inside of the vehicle cabin R on the basis of the received reflected wave. Specifically, the radar circuit unit 112 generates a transmission signal and outputs the transmission signal to the transmission antenna 113. Further, the radar circuit unit 112 acquires information on the inside of the vehicle cabin R by performing signal processing on a reception input signal. Specifically, the radar circuit unit 112 measures a position and the like of an object in the vehicle cabin R by performing signal processing on the reception input signal. For example, the radar circuit unit 112 measures a direction in which an occupant in the vehicle cabin R is located, a size of the occupant, and a moving speed of the occupant. Note that, in the first embodiment, a direction in which an object (occupant) is located, a size of the object, and a moving speed of the object are collectively referred to as a position and the like of the object (occupant).

The radar circuit unit 112 may be configured by a dedicated processing circuit, or may be configured by a processor, a memory, and the like, and a function may be implemented by the processor executing a program stored in the memory. Note that the radar circuit unit 112 constitutes a signal generating unit in the first embodiment. Details of the processing performed by the radar circuit unit 112 will be described later.

The transmission antenna 113 is disposed on the front surface 111a of the substrate 111, and includes a plurality of transmission antenna elements including a first transmission antenna element 113a and a second transmission antenna element 113b. For example, each transmission antenna element is made of printed wiring formed in a planar shape on the front surface 111a of the substrate 111. Further, for example, the first transmission antenna element 113a and the second transmission antenna element 113b are arranged at an interval along the W2 direction intersecting the X-axis direction.

Specifically, the first transmission antenna element 113a and the second transmission antenna element 113b are arranged at an interval along a virtual straight line L1 perpendicular to the X-axis direction and parallel to the front surface 111a of the substrate 111. In other words, the first transmission antenna element 113a and the second transmission antenna element 113b are arranged at an interval in the Y-axis direction and the Z-axis direction. The transmission signal generated by the radar circuit unit 112 is alternately output to the first transmission antenna element 113a and the second transmission antenna element 113b at predetermined intervals. The first transmission antenna element 113a and the second transmission antenna element 113b alternately radiate the transmission signal generated by the radar circuit unit 112 as a radio wave toward the vehicle cabin R at predetermined intervals. For example, the first transmission antenna element 113a and the second transmission antenna element 113b alternately radiate the transmission signal generated by the radar circuit unit 112 as a radio wave from the upper front part to the lower rear part of the vehicle cabin R at predetermined intervals.

The reception antenna 114 is disposed on the front surface 111a of the substrate 111. In other words, the front surface 111a of the substrate 111 is a plane on which the reception antenna is disposed. The reception antenna 114 includes a plurality of reception antenna elements including a first reception antenna element 114a and a second reception antenna element 114b. For example, the reception antenna 114 includes the first reception antenna element 114a, the second reception antenna element 114b, a third reception antenna element 114c, and a fourth reception antenna element 114d. Further, for example, each reception antenna element is made of printed wiring formed in a planar shape on the front surface 111a of the substrate 111. Furthermore, for example, the plurality of reception antenna elements is arranged at a predetermined interval d along the X-axis direction.

In other words, the first reception antenna element 114a, the second reception antenna element 114b, the third reception antenna element 114c, and the fourth reception antenna element 114d are arranged at a predetermined interval d along a virtual straight line L2 parallel to the X-axis direction. Further, in other words, for example, when viewed from the W1 direction that is a direction perpendicular to the front surface 111a of the substrate 111, the first reception antenna element 114a, the second reception antenna element 114b, the third reception antenna element 114c, and the fourth reception antenna element 114d are arranged so that the virtual straight line L2 connecting their respective centers is parallel to the X-axis direction. The reception antenna 114 receives a reflected wave of a radio wave emitted from the transmission antenna 113 and reflected by an object in the vehicle cabin R.

The interface unit 116 supplies power to each component of the substrate 111, and inputs and outputs signals from and to a device that is external to the radar unit 110. For example, the interface unit 116 inputs a signal output from the external device to the radar circuit unit 112, and outputs a signal output from the radar circuit unit 112 to the external device.

The housing 115 is formed in a box shape having a top plate 115a facing the front surface 111a of the substrate 111, and houses the substrate 111, the radar circuit unit 112, the transmission antenna 113, and the reception antenna 114. The housing 115 protects the internal components, and prevents the user of the vehicle 1 from touching the internal components or the internal configuration from being altered by the user of the vehicle 1. For example, the housing 115 is formed of a hard synthetic resin, and causes the base member 120 to hold the substrate 111.

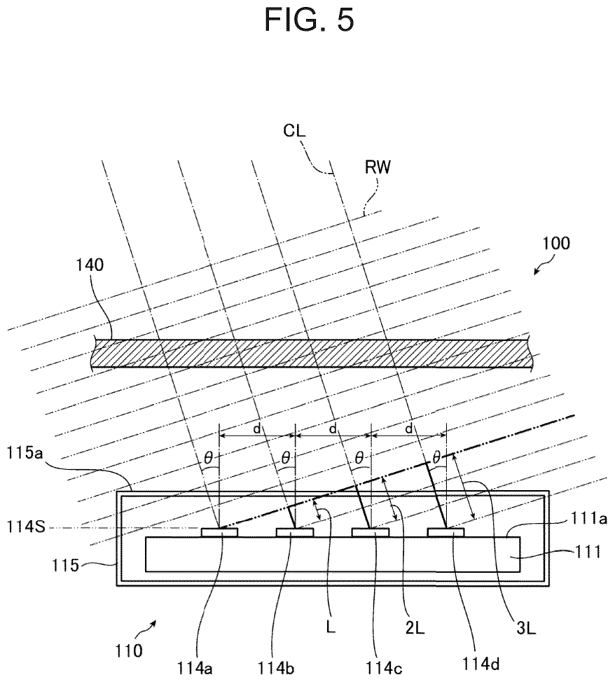

Next, a configuration for measuring the position and the like of the object on the basis of the reflected wave received by the reception antenna 114 will be described with reference to FIG. 5. FIG. 5 is a cross-sectional view illustrating the reflected wave received by the reception antenna 114 according to the first embodiment as viewed from the W2 direction in FIG. 2 parallel to the front surface 111a of the substrate 111. When the radio wave radiated from the transmission antenna 113 is reflected by the object, a reflected wave RW is generated. In FIG. 5, a case where the reflected wave RW is generated by an object located at a position (upper left in FIG. 5) where an angle with respect to the direction perpendicular to the front surface 111a of the substrate 111 is θ will be described as an example.

The reception antenna 114 receives the reflected wave RW by using the first reception antenna element 114a to the fourth reception antenna element 114d. A propagation distance of the reflected wave RW from the object to the first reception antenna element 114a to the fourth reception antenna element 114d is different for each antenna element. For example, assuming that a distance between adjacent antennas is d [m], a difference L [m] in propagation distance between the adjacent antennas is expressed by the following equation (1).

$$L = d \cdot sin θ \qquad ( 1 )$$

Assuming that ΔΦ [deg] is a phase difference of the reflected wave RW due to the difference L [m] in the propagation distance from the equation (1), the phase difference ΔΦ is expressed by the following equation (2).

$$Δ Φ = 2 π d \cdot sin θ / λ \qquad ( 2 )$$

The radar circuit unit 112 obtains the value of θ on the basis of the phase difference ΔΦ to measure the direction in which the object is located in an X direction and the size of the object, and measures the moving speed of the object on the basis of temporal changes of them.

As described above, radio waves are alternately radiated from the transmission antenna element 113a and the transmission antenna element 113b at predetermined intervals. Further, the transmission antenna element 113a and the transmission antenna element 113b are arranged at an interval in the W2 direction intersecting the X-axis direction in which the first reception antenna element 114a to the fourth reception antenna element 114d are arranged. Thus, the first reception antenna element 114a to the fourth reception antenna element 114d can measure the direction in which the object is located, the size of the object, and the moving speed of the object also in the W2 direction, by receiving the radio waves alternately radiated by the transmission antenna element 113a and the transmission antenna element 113b. Further, the radar circuit unit 112 constitutes a position measurement unit that measures the position of the object on the basis of the reflected wave RW in the first embodiment.

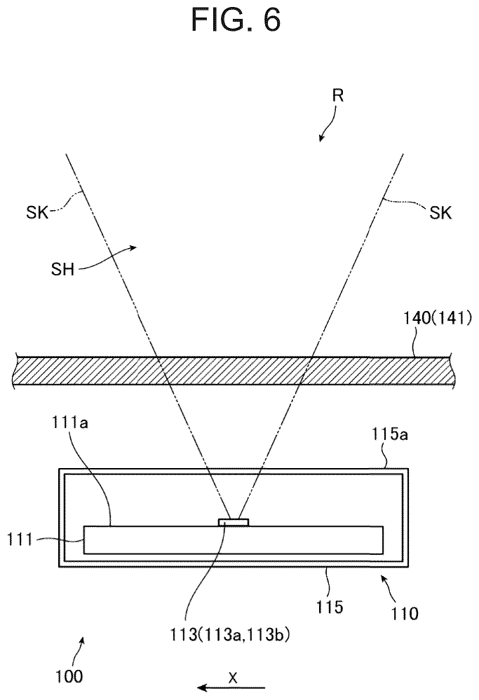

Next, the influence of surrounding members on the radio wave radiated from the transmission antenna 113 and the reflected wave RW based on the radio wave radiated from the transmission antenna 113 will be described with reference to FIGS. 2 and 6. Note that, in the first embodiment, the radio wave radiated from the transmission antenna 113 is also referred to as a transmission radio wave.

A radiation region SH is a region used for measurement of the position and the like of the object by the vehicle-cabin radar device 100 in a region where the transmission radio wave is radiated. For example, when measuring the position and the like of the occupant in the vehicle cabin R, the vehicle-cabin radar device 100 measures the position and the like of the occupant using the transmission radio wave radiated to the radiation region SH at least partially overlapping with a region in which the occupant can be present. Further, for example, the vehicle-cabin radar device 100 measures the position and the like of the occupant using the transmission radio wave radiated to the radiation region SH set on the basis of the position of the seat SE.

Specifically, in the X direction, the vehicle-cabin radar device 100 measures the position and the like of the object using the transmission radio wave radiated to the radiation region SH set so that a boundary SK on the right side of the radiation region SH (see FIG. 6) is located to the right of, in other words outside, the center portion of the front right seat SIR in the X-axis direction and a boundary SK on the left side of the radiation region SH (see FIG. 6) is located to the left of, in other words outside, the center portion of the front left seat S1L in the X axis direction. Further, in the W2 direction, the vehicle-cabin radar device 100 measures the position and the like of the object using the transmission radio wave radiated to the radiation region SH set so that a boundary SK on the W2 direction side (upper side) of the radiation region SH (see FIG. 2) is located on the W2 direction side (upper side) with respect to the upper end of the seat SE, and a boundary SK on the opposite side (W3 direction side, lower side) to the W2 direction of the radiation region SH (see FIG. 2) is located on the opposite side to the W2 direction with respect to at least a part of the seat plate S11 of the front seat S1.

On the propagation path of the transmission radio wave, reflection and refraction of the transmission radio wave occur at a boundary surface between regions whose respective electrical properties are discontinuous. For example, in a case where the top plate 115a of the housing 115 and the radar cover 140 are present between the transmission antenna 113 and the object to be measured, the transmission radio wave is reflected and refracted on the back surface and the front surface of the top plate 115a and on the back surface and the front surface of the radar cover 140.

In a case where the frequency is constant, assuming that a wavelength of the transmission radio wave in vacuum is λ0, relative permittivity of the top plate 115a is ε1, and relative permittivity of the radar cover 140 is ε2, a wavelength λ1 of the transmission radio wave in the top plate 115a and a wavelength λ2 of the transmission radio wave in the radar cover 140 are obtained by the following equations (3) and (4).

$$λ 1 = λ0 / √ ε1 \qquad ( 3 )$$

$$λ2 = λ0 / √ ε2 \qquad ( 4 )$$

Since ε1 and ε2 are values larger than 1, the transmission radio wave in the top plate 115a and the transmission radio wave in the radar cover 140 have wavelengths smaller than a wavelength of the transmission radio wave in air approximating the transmission radio wave in vacuum depending on the relative permittivity. For example, when the transmission radio wave propagates through two regions that differ from each other in relative permittivity for a predetermined distance, the phase lead of the transmission radio wave is faster in a region having a higher relative permittivity. Note that the relative permittivity also changes depending on the temperature. Due to the influence of heat generation by components arranged on the substrate 111 such as the radar circuit unit 112, the air temperature outside the vehicle 1, the air-conditioning of the vehicle cabin R, and the like, the air temperatures in the housing 115, a space between the housing 115 and the radar cover 140, and the vehicle cabin R are often different from each other. Thus, the value of the wavelength when the transmission radio wave passes through a space inside the housing 115, the value of the wavelength when the transmission radio wave passes through the space between the housing 115 and the radar cover 140, and the value of the wavelength when the transmission radio wave passes through the vehicle cabin R are different from each other.

Note that similarly to the transmission radio wave, the reflected wave RW also changes in wavelength when passing through a region having a different relative permittivity, and reflection and refraction of the transmission radio wave occur at a boundary surface between regions whose respective electrical properties are discontinuous on the propagation path. If the top plate 115a and the flat plate portion 141 are inclined with respect to the virtual straight line L2, the distance between each of the first reception antenna element 114a to the fourth reception antenna element 114d and the top plate 115a and the distance between each reception antenna element and the flat plate portion 141 are different for each reception antenna element. Thus, the influence of reflected waves generated between each reception antenna element and the top plate 115a and between each reception antenna element and the flat plate portion 141 is different for each reception antenna element, which may cause a decrease in measurement accuracy of the object measured by the vehicle-cabin radar device 100.

For this reason, the top plate 115a and the flat plate portion 141 according to the first embodiment are arranged in parallel to the front surface 111a of the substrate 111 in the radiation region SH. In other words, the housing 115 and the radar cover 140 are formed to be parallel to the front surface 111a of the substrate 111 in the radiation region SH, a portion which is included in the housing 115 and which is formed to be parallel to the front surface 111a of the substrate 111 constitutes the top plate 115a, and a portion which is included in the radar cover 140 and which is formed to be parallel to the front surface 111a of the substrate 111 constitutes the flat plate portion 141.

Thus, in the vehicle-cabin radar device 100, the distance between each reception antenna element and the top plate 115a and the distance between each reception antenna element and the flat plate portion 141 are uniform, thereby suppressing a difference between the reception antenna elements in the influence of the reflected waves generated between each reception antenna element and the top plate 115a and between each reception antenna element and the flat plate portion 141. Note that, in order to suppress diffuse reflection of the transmission radio wave and the reflected wave RW, each of the top plate 115a and the flat plate portion 141 is desirably smooth as much as possible on the front surface and the back surface in the W1 direction. For example, each of the top plate 115a and the flat plate portion 141 is desirably formed as an integrated component having no commissure in the W2 direction, and heights of pits and projections on the front surface and the back surface are desirably equal to or less than 1/10 of the wavelength.

Further, as described above, the vehicle-cabin radar device 100 measures the position and the like of the object on the basis of the phase difference of the reflected wave RW caused by the propagation distance of the reflected wave RW from the object to each reception antenna element. Accordingly, in the vehicle-cabin radar device 100, in a case where the change in the wavelength generated on the propagation path until the reflected wave RW is received by the reception antenna 114 after radiation of the transmission radio wave from the transmission antenna 113 is different for each of the transmission antenna element 113a and the transmission antenna element 113b and for each of the reception antenna elements, an error occurs in the measurement result of the position and the like of the object.

In the first embodiment, the top plate 115a and the flat plate portion 141 are arranged in parallel to the front surface 111a of the substrate 111 in the radiation region SH. Thereby, the vehicle-cabin radar device 100 suppresses the difference in the propagation distance of the transmission radio wave between the transmission antenna elements and the difference in the propagation distance of the reflected wave RW between the reception antenna elements in each of regions: the space inside the housing 115, the space between the housing 115 and the radar cover 140, and the vehicle cabin R, thereby suppressing, in each of these regions, the influence of a change in wavelength due to, for example, a difference in air temperature between the regions on the measurement accuracy. Note that, in the first embodiment, the vehicle-cabin radar device 100 is configured so that the radiation region SH of the transmission radio wave and a reception region that is the region of the reflected wave RW used by the reception antenna 114 for measuring the object overlap each other, by matching antenna element characteristics of the transmission antenna element and the reception antenna element.

Further, each of the top plate 115a and the flat plate portion 141 is formed so that the material thereof is uniform and the thickness thereof is uniform in the direction along the front surface 111a of the substrate 111 in the radiation region SH. Thereby, the vehicle-cabin radar device 100 suppresses a difference in phase lead of the transmission radio wave and the reflected wave RW between the transmission antenna element 113a and the transmission antenna element 113b and between the first reception antenna element 114a to the fourth reception antenna element 114d when the transmission radio wave and the reflected wave RW pass through the top plate 115a of the housing 115 and the radar cover 140.

Further, as described above, reflection of the transmission radio wave and the reflected wave RW occurs at a boundary surface between regions whose respective electrical properties are discontinuous. Accordingly, as the distance between the transmission antenna 113 and the flat plate portion 141 decreases, the number of times of reflection per unit time between the transmission antenna 113 and the flat plate portion 141 increases, and thereby the measurement accuracy of the object measured by the vehicle-cabin radar device 100 may decrease. Therefore, the flat plate portion 141 is disposed so that the distance m between a front surface 114S (surface on the vehicle cabin R side) of each of the transmission antenna 113 and the reception antenna 114 and the back surface (surface on the opposite side to the vehicle cabin R) of the flat plate portion 141 is equal to or more than the double of the wavelength of the transmission radio wave. Thereby, the vehicle-cabin radar device 100 suppresses the influence of the reflection of the transmission radio wave by the flat plate portion 141. Note that, when the transmission antenna radiates the transmission radio wave so that the wavelength thereof changes, the double of the wavelength of the transmission radio wave may be the double of the average wavelength of the transmission radio wave, the double of the median value of the wavelength of the transmission radio wave, or the double of the maximum wavelength of the transmission radio wave.

As described above, in the vehicle-cabin radar device 100 according to the first embodiment, the top plate 115a and the flat plate portion 141 are arranged in parallel to the front surface 111a of the substrate 111 in the radiation region SH. Thus, the vehicle-cabin radar device 100 can suppress differences in propagation distances of the transmission radio wave and the reflected wave RW between the transmission antenna element 113a and the transmission antenna element 113b, and between the first reception antenna element 114a to the fourth reception antenna element 114d in each of regions: the space inside the housing 115, the space between the housing 115 and the radar cover 140, and the vehicle cabin R. Thereby, the vehicle-cabin radar device 100 can suppress the influence of the top plate 115a and the flat plate portion 141 on measurement accuracy when measuring the position and the like of the object.

Further, the vehicle-cabin radar device 100 according to the first embodiment is formed to be uniform in the direction along the front surface 111a of the substrate 111 in the radiation region SH. Thus, the vehicle-cabin radar device 100 can suppress the difference in the phase lead of the transmission radio wave and the reflected wave RW between the transmission antenna element 113a and the transmission antenna element 113b and between the first reception antenna element 114a to the fourth reception antenna element 114d when the transmission radio wave and the reflected wave RW pass through the top plate 115a of the housing 115 and the radar cover 140. Thereby, the vehicle-cabin radar device 100 can suppress the influence of the top plate 115a and the flat plate portion 141 on the measurement accuracy when measuring the position and the like of the object.

Further, each of the top plate 115a and the flat plate portion 141 according to the first embodiment is formed of a uniform material in the radiation region SH. Thus, the vehicle-cabin radar device 100 can suppress the difference in the phase lead of the transmission radio wave and the reflected wave RW between the transmission antenna element 113a and the transmission antenna element 113b and between the first reception antenna element 114a to the fourth reception antenna element 114d when the transmission radio wave and the reflected wave RW pass through the top plate 115a of the housing 115 and the radar cover 140. Thereby, the vehicle-cabin radar device 100 can suppress the influence of the top plate 115a and the flat plate portion 141 on the measurement accuracy when measuring the position and the like of the object.

Note that the top plate 115a and the flat plate portion 141 according to the first embodiment are formed to be parallel to the front surface 111a of the substrate 111 in the radiation region SH which is the region of the transmission radio wave used for measuring the position and the like of the object, but are not limited thereto. The top plate and the flat plate portion only need to be arranged in parallel to at least the direction in which the first reception antenna element and the second reception antenna element are arranged, that is, in parallel to the virtual straight line L2. For example, the top plate and the flat plate portion may be formed in a curved plate shape having a curved surface curved in the radiation region SH when viewed in the direction of the virtual straight line L2, or may be arranged to be inclined with respect to the front surface of the substrate.

Further, the vehicle-cabin radar device 100 according to the first embodiment includes the plurality of transmission antenna elements arranged along the W2 direction and the plurality of reception antenna elements arranged along the X-axis direction, but is not limited thereto. The plurality of transmission antenna elements and the plurality of reception antenna elements only need to be arranged along directions intersecting each other. For example, the vehicle-cabin radar device may include a plurality of transmission antenna elements arranged along the X-axis direction and a plurality of reception antenna elements arranged along the W2 direction.

Further, the vehicle-cabin radar device 100 according to the first embodiment includes two transmission antenna elements and four reception antenna elements, but is not limited thereto. The vehicle-cabin radar device only needs to include transmission antenna elements and reception antenna elements the number of which is suitable for the desired radar resolution. The vehicle-cabin radar device may include only one transmission antenna element, may include four or more reception antenna elements, or may include a plurality of reception antenna elements arranged in a matrix along the X direction and the W2 direction.

Further, when a member having high conductivity, for example, a member formed of a metal material is disposed on the propagation path of the transmission radio wave and the reflection wave, the transmission radio wave and the reflected wave are attenuated or blocked out. For this reason, the housing 115 and the radar cover 140 according to the first embodiment are formed of a hard synthetic resin, but are not limited thereto. The housing and the radar cover only need to be formed of a non-metallic material having low conductivity at least in the radiation region SH. For example, the back surface side of the housing (the side opposite to the vehicle cabin) may be formed of a metal material, or the radar cover may be formed of a material other than synthetic resin such as glass.

Further, the transmission antenna 113 and the reception antenna 114 according to the first embodiment are arranged on the front surface 111a which is a single continuous surface of the substrate 111, but are not limited thereto. The transmission antenna and the reception antenna only need to be arranged on surfaces arranged so that positions in a direction perpendicular to the surfaces are substantially the same. For example, when the substrate of the radar unit includes a plurality of substrates, the transmission antenna and the reception antenna may be arranged on surfaces of respective different substrates, may be arranged on a surface different from the surface of the substrate on which the radar circuit unit is disposed, or may be arranged on a surface of a substrate or the like disposed on an IC constituting the radar circuit unit.

Further, the vehicle-cabin radar device 100 according to the first embodiment includes the housing 115 that houses the substrate 111, the radar circuit unit 112, the transmission antenna 113, and the reception antenna 114, but is not limited thereto. The vehicle-cabin radar device may have a configuration in which only the interior member is disposed between the transmission and reception antennas and the vehicle cabin.

Further, the substrate 111 according to the first embodiment is disposed in the upper front part of the vehicle cabin R so that the front surface 111a faces the lower rear part of the vehicle cabin R, and the first transmission antenna element 113a and the second transmission antenna element 113b are configured to radiate the transmission signal generated by the radar circuit unit 112 as a radio wave from the upper front part toward the lower rear part of the vehicle cabin R, but it is not limited thereto. The transmission antenna only needs to be configured to radiate the transmission signal generated by the signal generating unit toward the vehicle cabin as a radio wave. For example, the transmission antenna may be configured to radiate the transmission signal generated by the signal generating unit as a radio wave from the upper part toward the lower part of the vehicle cabin, may be configured to radiate the transmission signal generated by the signal generating unit as a radio wave from the front part toward the rear part of the vehicle cabin, or may be configured to radiate the transmission signal generated by the signal generating unit as a radio wave from a front part of one of left and right sides toward a rear part of the other of the left and right sides of the vehicle cabin.

Further, each of the top plate 115a and the flat plate portion 141 according to the first embodiment is formed of a uniform material in the radiation region SH, but is not limited thereto. Each of the top plate and the flat plate portion only needs to be formed of a material that is uniform at least in a direction in which the plurality of reception antenna elements is arranged. For example, the material may be non-uniform in a thickness direction. Specifically, instead of the radar cover, a roof member formed of a composite material formed by overlapping a plurality of types of members having respective different materials may be disposed between the transmission and reception antennas and the vehicle cabin in a direction perpendicular to the front surface of the substrate.

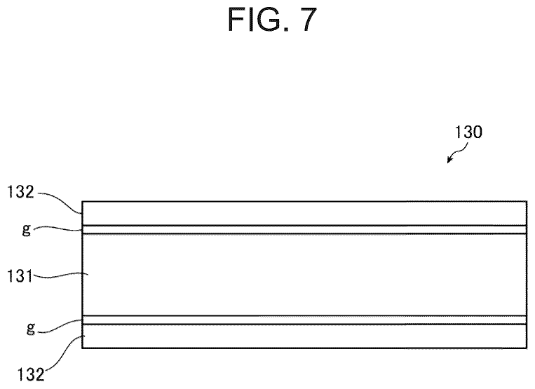

FIG. 7 is a cross-sectional view illustrating an example of the roof member according to the first embodiment. For example, the roof member 130 is formed of a composite material in which both surfaces of a lightweight foam material 131 are sandwiched between roof fabrics 132 which are design materials such as felt or nonwoven fabric, and the foam material 131 and the roof fabrics 132 are bonded by glue g. Note that reflection of the transmission radio wave and the reflected wave occurs at a boundary surface between regions whose respective electrical properties are discontinuous. Thus, it is more preferable that each of the members arranged between the transmission and reception antennas and the vehicle cabin in the direction perpendicular to the front surface of the substrate is formed of a material that is uniform also in the thickness direction.

Further, the reception antenna 114 according to the first embodiment includes the first reception antenna element 114a, the second reception antenna element 114b, the third reception antenna element 114c, and the fourth reception antenna element 114d, but is not limited thereto. The reception antenna only needs to have at least the first reception antenna element and the second reception antenna element. The reception antenna may have only the first reception antenna element and the second reception antenna element, or may have three or five or more reception antenna elements.

Note that any component of the embodiment can be modified or any component of the embodiment can be omitted.

### INDUSTRIAL APPLICABILITY

A vehicle-cabin radar device 100 according to the present disclosure can be used to improve measurement accuracy when an object in a vehicle cabin of a vehicle is measured by a radar.

REFERENCE SIGNS LIST

1: vehicle, 100: vehicle-cabin radar device, 111a: plane,
112: radar circuit unit (signal generating unit), 113: transmission
antenna, 113a: first transmission antenna element, 113b: second
transmission antenna element, 114: reception antenna, 114a: first
reception antenna element, 114b: second reception antenna element,
115: housing, 140: radar cover (interior member), 141: flat plate
portion, L2: virtual straight line, R: vehicle cabin, W1: direction,
W2: direction, X: axial direction (vehicle width direction), Y:
axial direction (vehicle height direction)

1. A vehicle-cabin radar device, comprising:
signal generating circuitry to generate a transmission signal;
a transmission antenna to radiate the transmission signal generated by the signal generating circuitry toward a vehicle cabin as a radio wave;
a reception antenna including a first reception antenna element and a second reception antenna element to receive a reflected wave of the radio wave radiated from the transmission antenna, the first reception antenna element and the second reception antenna element being provided at an interval; and
an interior member exposed to the vehicle cabin, wherein
the interior member includes a plate-shaped flat plate portion that is provided between the transmission and reception antennas and the vehicle cabin in a direction perpendicular to a plane on which the reception antenna is provided, the flat plate portion being provided in parallel to a virtual straight line connecting the first reception antenna element and the second reception antenna element.

2. The vehicle-cabin radar device according to claim 1, wherein
the flat plate portion is formed to have a uniform thickness in a direction of the virtual straight line.

3. The vehicle-cabin radar device according to claim 2, wherein
the transmission antenna is provided on the plane, and
the flat plate portion is provided in parallel to the plane.

4. The vehicle-cabin radar device according to claim 3, wherein
the transmission antenna includes a first transmission antenna element and a second transmission antenna element to radiate the transmission signal generated by the signal generating circuitry toward the vehicle cabin as the radio wave, and
the first transmission antenna element and the second transmission antenna element are provided at an interval along a direction intersecting the virtual straight line.

5. The vehicle-cabin radar device according to claim 4, wherein
the first transmission antenna element and the second transmission antenna element are provided at an interval in a vehicle height direction.

6. The vehicle-cabin radar device according to claim 5, wherein
the first reception antenna element and the second reception antenna element are provided so that the virtual straight line is parallel to a vehicle width direction.

7. The vehicle-cabin radar device according to claim 6, wherein
a distance between the transmission antenna and the flat plate portion is equal to or more than a double of a wavelength of the radio wave radiated from the transmission antenna.

8. The vehicle-cabin radar device according to claim 7, wherein
the flat plate portion is formed of a material that is uniform in a direction along the virtual straight line.

9. The vehicle-cabin radar device according to claim 8, wherein
the flat plate portion is formed of a material that is uniform in a thickness direction.

10. The vehicle-cabin radar device according to claim 9, wherein
the flat plate portion is formed of a non-metallic material.

11. The vehicle-cabin radar device according to claim 10, comprising:
a housing to accommodate the signal generating circuitry, the transmission antenna, and the reception antenna, wherein
the flat plate portion is provided between the housing and the vehicle cabin in the direction perpendicular to the plane.

12. A vehicle comprising:
the vehicle-cabin radar device according to claim 1.
